(19) United States
(12) Patent Application Publication
(10) Pub. No.: US 2026/0046796 A1
(43) Pub. Date: Feb. 12, 2026

(54) CELL PRESENCE DETECTION ENHANCEMENT

(71) Applicant: QUALCOMM Incorporated, San Diego, CA (US)

(72) Inventors: Kiran VENUGOPAL, Green Brook, NJ (US); Yan ZHOU, San Diego, CA (US); Jae Ho RYU, San Diego, CA (US); Raghu Narayan CHALLA, San Diego, CA (US); Yongle WU, San Diego, CA (US); Yong LI, San Diego, CA (US)

(21) Appl. No.: 18/796,270

(22) Filed: Aug. 6, 2024

(51) Int. Cl. H04W 56/00; H04W 52/36

(52) U.S. Cl. CPC H04W 56/0015; H04W 52/36

(57) ABSTRACT

Methods, systems, and devices for method for wireless communication are described. A user equipment (UE) may receive a primary synchronization signal spanning a first set of resource blocks. The UE may then receive a physical broadcast channel transmission associated with the primary synchronization signal. In some cases, the physical broadcast channel transmission may span a second set of resource blocks, where a numerical quantity of the first set of resource blocks is same as a numerical quantity of the second set of resource blocks. The UE then communicates with a network entity in accordance with receiving the primary synchronization signal and the physical broadcast channel transmission associated with the primary synchronization signal.

### FIELD OF TECHNOLOGY

The following relates to method for wireless communication, including cell presence detection enhancement.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a primary synchronization signal spanning a first set of multiple resource blocks, receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicating with a network entity in accordance with receiving the primary synchronization signal and the physical broadcast channel transmission associated with the primary synchronization signal.

A UE for wireless communications is described. The UE may include one or more memories storing processor executable code, and one or more processors coupled with the one or more memories. The one or more processors may individually or collectively be operable to execute the code to cause the UE to receive a primary synchronization signal spanning a first set of multiple resource blocks, receive a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicate with a network entity in accordance with receiving the primary synchronization signal and the physical broadcast channel transmission associated with the primary synchronization signal.

Another UE for wireless communications is described. The UE may include means for receiving a primary synchronization signal spanning a first set of multiple resource blocks, means for receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and means for communicating with a network entity in accordance with receiving the primary synchronization signal and the physical broadcast channel transmission associated with the primary synchronization signal.

A non-transitory computer-readable medium storing code for wireless communications is described. The code may include instructions executable by one or more processors to receive a primary synchronization signal spanning a first set of multiple resource blocks, receive a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicate with a network entity in accordance with receiving the primary synchronization signal and the physical broadcast channel transmission associated with the primary synchronization signal. In some examples of the method, UEs, and non-transitory computer-readable medium described herein, at least one resource block of the first set of multiple resource blocks may be empty.

In some examples of the method, UEs, and non-transitory computer-readable medium described herein, receiving the primary synchronization signal may include operations, features, means, or instructions for receiving the primary synchronization signal mapped to a first subset of the first set of multiple resource blocks and receiving a synchronization signal block presence indicator mapped to a second subset of the first set of multiple resource blocks. In some examples of the method, UEs, and non-transitory computer-readable medium described herein, one or more tones located between the first subset of first set of multiple resource blocks and the second subset of the first set of multiple resource blocks may be empty.

In some examples of the method, UEs, and non-transitory computer-readable medium described herein, receiving the primary synchronization signal may include operations, features, means, or instructions for receiving the primary synchronization signal mapped to a first subset of the first set of multiple resource blocks and receiving a secondary synchronization signal mapped to a second subset of the first set of multiple resource blocks.

In some examples of the method, UEs, and non-transitory computer-readable medium described herein, one or more tones located between the first subset of first set of multiple resource blocks and the second subset of the first set of multiple resource blocks may be empty.

In some examples of the method, UEs, and non-transitory computer-readable medium described herein, receiving the primary synchronization signal may include operations, features, means, or instructions for receiving a primary synchronization signal burst including a first primary synchronization signal and a second primary synchronization signal, where each of the first primary synchronization signal and the second primary synchronization signal span the first set of multiple resource blocks.

In some examples of the method, UEs, and non-transitory computer-readable medium described herein, receiving the primary synchronization signal may include operations, features, means, or instructions for detecting an energy pattern corresponding to the primary synchronization signal, where the energy pattern indicates that at least one resource block of the first set of multiple resource blocks may be empty. In some examples of the method, UEs, and non-transitory computer-readable medium described herein, the numerical quantity of the first set of multiple resource blocks includes twenty resource blocks.

A method for wireless communications by a UE is described. The method may include receiving a power boost symbol prior to receiving a primary synchronization signal, the power boost symbol spanning a physical resource block in a synchronization signal block bandwidth, receiving the primary synchronization signal and a secondary synchronization signal based on the power boost symbol, and communicating with a network entity in accordance with receiving the primary synchronization signal and the secondary synchronization signal.

A UE for wireless communications is described. The UE may include one or more memories storing processor executable code, and one or more processors coupled with the one or more memories. The one or more processors may individually or collectively be operable to execute the code to cause the UE to receive a power boost symbol prior to receiving a primary synchronization signal, the power boost symbol spanning a physical resource block in a synchronization signal block bandwidth, receive the primary synchronization signal and a secondary synchronization signal based on the power boost symbol, and communicate with a network entity in accordance with receiving the primary synchronization signal and the secondary synchronization signal.

Another UE for wireless communications is described. The UE may include means for receiving a power boost symbol prior to receiving a primary synchronization signal, the power boost symbol spanning a physical resource block in a synchronization signal block bandwidth, means for receiving the primary synchronization signal and a secondary synchronization signal based on the power boost symbol, and means for communicating with a network entity in accordance with receiving the primary synchronization signal and the secondary synchronization signal.

A non-transitory computer-readable medium storing code for wireless communications is described. The code may include instructions executable by one or more processors to receive a power boost symbol prior to receiving a primary synchronization signal, the power boost symbol spanning a physical resource block in a synchronization signal block bandwidth, receive the primary synchronization signal and a secondary synchronization signal based on the power boost symbol, and communicate with a network entity in accordance with receiving the primary synchronization signal and the secondary synchronization signal.

In some examples of the method, UEs, and non-transitory computer-readable medium described herein, receiving the power boost symbol may include operations, features, means, or instructions for receiving a set of tones associated with the power boost symbol in accordance with a sequence. In some examples of the method, UEs, and non-transitory computer-readable medium described herein, the sequence includes a low peak to average power ratio computer generated sequence.

Some examples of the method, UEs, and non-transitory computer-readable medium described herein may further include operations, features, means, or instructions for detecting a correlation between a received energy of one or more tones associated with power boost symbol and an expected energy associated with the power boost symbol, where receiving the power boost symbol may be based on detecting the correlation.

In some examples of the method, UEs, and non-transitory computer-readable medium described herein, at least one tone associated with the power boost symbol may be boosted by a factor relative to at least one tone associated with the secondary synchronization signal. In some examples of the method, UEs, and non-transitory computer-readable medium described herein, a set of remaining physical resource blocks in the synchronization signal block bandwidth may be empty.

A method for wireless communications by a network entity is described. The method may include outputting a primary synchronization signal spanning a first set of multiple resource blocks, outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicating with a UE in accordance with outputting the primary synchronization signal and the physical broadcast channel transmission associated with the primary synchronization signal.

A network entity for wireless communications is described. The network entity may include one or more memories storing processor executable code, and one or more processors coupled with the one or more memories. The one or more processors may individually or collectively be operable to execute the code to cause the network entity to output a primary synchronization signal spanning a first set of multiple resource blocks, output a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicate with a UE in accordance with outputting the primary synchronization signal and the physical broadcast channel transmission associated with the primary synchronization signal.

Another network entity for wireless communications is described. The network entity may include means for outputting a primary synchronization signal spanning a first set of multiple resource blocks, means for outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and means for communicating with a UE in accordance with outputting the primary synchronization signal and the physical broadcast channel transmission associated with the primary synchronization signal.

A non-transitory computer-readable medium storing code for wireless communications is described. The code may include instructions executable by one or more processors to output a primary synchronization signal spanning a first set of multiple resource blocks, output a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks, and communicate with a UE in accordance with outputting the primary synchronization signal and the physical broadcast channel transmission associated with the primary synchronization signal. In some examples of the method, network entities, and non-transitory computer-readable medium described herein, at least one resource block of the first set of multiple resource blocks may be empty.

In some examples of the method, network entities, and non-transitory computer-readable medium described herein, outputting the primary synchronization signal may include operations, features, means, or instructions for outputting the primary synchronization signal mapped to a first subset of the first set of multiple resource blocks and outputting a synchronization signal block presence indicator mapped to a second subset of the first set of multiple resource blocks.

In some examples of the method, network entities, and non-transitory computer-readable medium described herein, one or more tones located between the first subset of first set of multiple resource blocks and the second subset of the first set of multiple resource blocks may be empty.

In some examples of the method, network entities, and non-transitory computer-readable medium described herein, outputting the primary synchronization signal may include operations, features, means, or instructions for outputting the primary synchronization signal mapped to a first subset of the first set of multiple resource blocks and outputting a secondary synchronization signal mapped to a second subset of the first set of multiple resource blocks.

In some examples of the method, network entities, and non-transitory computer-readable medium described herein, one or more tones located between the first subset of first set of multiple resource blocks and the second subset of the first set of multiple resource blocks may be empty.

In some examples of the method, network entities, and non-transitory computer-readable medium described herein, outputting the primary synchronization signal may include operations, features, means, or instructions for outputting a primary synchronization signal burst including a first primary synchronization signal and a second primary synchronization signal, where each of the first primary synchronization signal and the second primary synchronization signal span the first set of multiple resource blocks.

In some examples of the method, network entities, and non-transitory computer-readable medium described herein, outputting the primary synchronization signal may include operations, features, means, or instructions for outputting the primary synchronization signal in accordance with an energy pattern, where the energy pattern indicates that at least one resource block of the first set of multiple resource blocks may be empty. In some examples of the method, network entities, and non-transitory computer-readable medium described herein, the numerical quantity of the first set of multiple resource blocks includes twenty resource blocks.

A method for wireless communications by a network entity is described. The method may include outputting a power boost symbol prior to outputting a primary synchronization signal, the power boost symbol spanning a physical resource block in a synchronization signal block bandwidth, outputting the primary synchronization signal and a secondary synchronization signal based on the power boost symbol, and communicating with a UE in accordance with outputting the primary synchronization signal and the secondary synchronization signal.

A network entity for wireless communications is described. The network entity may include one or more memories storing processor executable code, and one or more processors coupled with the one or more memories. The one or more processors may individually or collectively be operable to execute the code to cause the network entity to output a power boost symbol prior to outputting a primary synchronization signal, the power boost symbol spanning a physical resource block in a synchronization signal block bandwidth, output the primary synchronization signal and a secondary synchronization signal based on the power boost symbol, and communicate with a UE in accordance with outputting the primary synchronization signal and the secondary synchronization signal.

Another network entity for wireless communications is described. The network entity may include means for outputting a power boost symbol prior to outputting a primary synchronization signal, the power boost symbol spanning a physical resource block in a synchronization signal block bandwidth, means for outputting the primary synchronization signal and a secondary synchronization signal based on the power boost symbol, and means for communicating with a UE in accordance with outputting the primary synchronization signal and the secondary synchronization signal.

A non-transitory computer-readable medium storing code for wireless communications is described. The code may include instructions executable by one or more processors to output a power boost symbol prior to outputting a primary synchronization signal, the power boost symbol spanning a physical resource block in a synchronization signal block bandwidth, output the primary synchronization signal and a secondary synchronization signal based on the power boost symbol, and communicate with a UE in accordance with outputting the primary synchronization signal and the secondary synchronization signal.

In some examples of the method, network entities, and non-transitory computer-readable medium described herein, outputting the power boost symbol may include operations, features, means, or instructions for outputting a set of tones associated with the power boost symbol in accordance with a sequence. In some examples of the method, network entities, and non-transitory computer-readable medium described herein, the sequence includes a low peak to average power ratio computer generated sequence.

In some examples of the method, network entities, and non-transitory computer-readable medium described herein, an energy of one or more tones associated with power boost symbol may have a correlation with an expected energy associated with the power boost symbol and outputting the power boost symbol may be based on the correlation.

In some examples of the method, network entities, and non-transitory computer-readable medium described herein, at least one tone associated with the power boost symbol may be boosted by a factor relative to at least one tone associated with the secondary synchronization signal. In some examples of the method, network entities, and non-transitory computer-readable medium described herein, a set of remaining physical resource blocks in the synchronization signal block bandwidth may be empty.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports cell presence detection enhancement in accordance with one or more aspects of the present disclosure.

FIG. 2 shows an example of a wireless communications system that supports cell presence detection enhancement in accordance with one or more aspects of the present disclosure.

FIGS. 3A, 3B and 3C show examples of signaling structures that support cell presence detection enhancement in accordance with one or more aspects of the present disclosure.

FIG. 4 shows an example of a signaling structure that supports cell presence detection enhancement in accordance with one or more aspects of the present disclosure.

FIG. 5 shows an example of a process flow that supports cell presence detection enhancement in accordance with one or more aspects of the present disclosure.

FIG. 6 shows an example of a process flow that supports cell presence detection enhancement in accordance with one or more aspects of the present disclosure.

FIGS. 7 and 8 show block diagrams of devices that support cell presence detection enhancement in accordance with one or more aspects of the present disclosure.

FIG. 9 shows a block diagram of a communications manager that supports cell presence detection enhancement in accordance with one or more aspects of the present disclosure.

FIG. 10 shows a diagram of a system including a device that supports cell presence detection enhancement in accordance with one or more aspects of the present disclosure.

FIGS. 11 and 12 show block diagrams of devices that support cell presence detection enhancement in accordance with one or more aspects of the present disclosure.

FIG. 13 shows a block diagram of a communications manager that supports cell presence detection enhancement in accordance with one or more aspects of the present disclosure.

FIG. 14 shows a diagram of a system including a device that supports cell presence detection enhancement in accordance with one or more aspects of the present disclosure.

FIGS. 15 through 18 show flowcharts illustrating methods that support cell presence detection enhancement in accordance with one or more aspects of the present disclosure.

### DETAILED DESCRIPTION

In some wireless communications systems, one or more wireless communications device may establish a connection based on an initial cell search. A UE may perform a cell search procedure for the UE to acquire time and frequency synchronization with a cell. In some cases, the initial cell search may be based on a synchronization signal block including a primary synchronization signal, a physical broadcast channel transmission and a secondary synchronization signal. In some examples, the synchronization signal block may span four orthogonal frequency division multiplexing (OFDM) symbols with one symbol for the primary synchronization signal, two symbols for the physical broadcast channel, and one symbol carrying the secondary synchronization signal multiplexed with the physical broadcast channel in the frequency domain. In some cases, the primary synchronization signal may span a length of 127 frequency domain-based M-sequence (mapped to 127 subcarriers). A UE may detect the presence of a cell based on a synchronization signal block energy pattern. In particular, the UE may perform a correlation between a primary synchronization signal and each potential synchronization signal block candidate based on energy detection.

To enhance techniques for primary synchronization signal detection, one or more aspects of the present disclosure provides for redesigning the primary synchronization signal. In particular, the primary synchronization signal may be updated to span a greater quantity of resource blocks to facilitate energy-based primary synchronization signal detection. In some examples, the UE may receive a primary synchronization signal spanning a first set of resource blocks. The UE may then receive a physical broadcast channel transmission associated with the primary synchronization signal, the physical broadcast channel transmission spanning a second set of resource blocks. A numerical quantity of the first set of resource blocks may be the same as a numerical quantity of the second set of resource blocks. In some cases, at least one resource block of the first set of resource blocks may be empty. For instance, the primary synchronization signal may include a primary synchronization signal sequence spanning 20 resource blocks with the 2nd and 19th resource blocks left empty as a distinguishable energy pattern. In some examples, the primary synchronization signal sequence may occupy all 20 resource blocks. In some examples, the UE may receive a composite primary synchronization signal sequence including a primary synchronization signal and a synchronization signal block presence indicator. The composite primary synchronization signal, in another example, may include a primary synchronization signal multiplexed with a secondary synchronization signal in a frequency domain.

Additionally, or alternatively, the UE may receive a power boost symbol for cell presence detection. The UE may receive a power boost symbol prior to receiving the primary synchronization signal, the power boost symbol spanning a physical resource block in a synchronization signal block bandwidth. In some cases, at least one tone associated with the power boost symbol may be boosted by a factor relative to at least one tone associated with the secondary synchronization signal.

Aspects of the disclosure are initially described in the context of wireless communications systems. Aspects of the disclosure are further illustrated by and described with reference to signaling structures and process flows. Aspects of the disclosure are further illustrated by and described with reference to apparatus diagrams, system diagrams, and flowcharts that relate to cell presence detection enhancement.

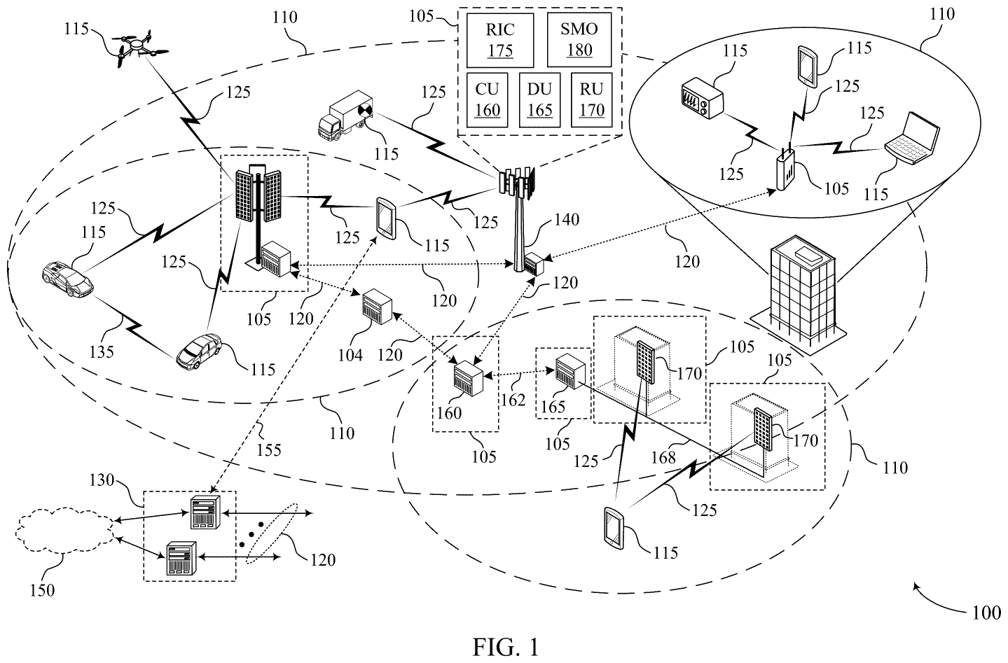

FIG. 1 shows an example of a wireless communications system 100 that supports cell presence detection enhancement in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may be a device such as a cellular phone, a smart phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, wireless devices may use a synchronization signal block for initial cell search when establishing communication with a network entity 105. In some cases, the synchronization signal block may span 4 OFDM symbols with 1 symbol including a primary synchronization signal, 2 symbols including a physical broadcast channel transmission, and 1 symbol including a secondary synchronization signal FDM-ed with a physical broadcast channel transmission.

In some examples, a primary synchronization signal may use a length 127 frequency domain-based M-sequence (mapped to 127 subcarriers). In some cases, the primary synchronization signal may be mapped to a sequence (e.g., there may be three possible sequences for the primary synchronization signal). In some cases, the secondary synchronization signal may use length 127 frequency domain-based Gold code sequence (2 M-sequences mapped to 127 subcarriers). The secondary synchronization signal can have (or be mapped to) 1008 possible sequences. The physical broadcast channel transmission may be QPSK modulated and be coherently demodulated using an associated demodulation reference signal. However, frequent synchronization signal block transmissions may result is increased energy consumption. Less frequent synchronization signal block transmissions while resulting in lower energy consumption, may lead to higher initial access latency, causing performance loss and inability to support low latency type applications.

In some examples, (e.g., in frequency range 2 (FR2)), to reduce synchronization signal block transmission energy or synchronization signal block transmission overhead while maintaining same cell presence detection latency, the UE 115 may use a dual-burst synchronization signal. The dual-burst synchronization signal may include a 1-symbol discovery reference signal (DRS) burst for cell presence detection and an X-symbol synchronization signal block burst for cell identification. In some cases, the 1-symbol DRS may include 1-symbol common primary synchronization signal, or limited search hypothesis. The X-symbol synchronization signal block can have a value of X=3 (e.g., 1-symbol cell specific secondary synchronization signal, and 2-symbol physical broadcast channel). In an energy efficient design, primary synchronization signal-like sequence may be separately transmitted as a compact burst more frequently, while the remaining synchronization signal block (secondary synchronization signal and physical broadcast channel) may be transmitted less often. In some examples, a primary synchronization signal and a secondary synchronization signal may be widely separated and may cause different time/frequency error compared to other synchronization signal block structures.

In some cases, a UE 115 may continuously monitor for potential synchronization signal block in a time window, adding to power and computation. In some examples, the UE 115 may consider multiple synchronization signal block hypothesis after detecting a primary synchronization signal peak (e.g., a peak in an energy corresponding to the primary synchronization signal). In some cases, a secondary synchronization signal or a physical broadcast channel may or may not be present in the same cycle after detection of the primary synchronization signal peak. This continuous monitoring may lead to increased energy usage at the UE 115.

To enhance cell presence detection, in accordance with one or more aspects of the present disclosure, the UE 115 may receive a primary synchronization signal spanning a first set of resource blocks. The UE 115 may further receive a physical broadcast channel transmission associated with the primary synchronization signal, the physical broadcast channel transmission spanning a second set of resource blocks. In some cases, a numerical quantity of the first set of resource blocks is same as a numerical quantity of the second set of resource blocks. The UE 115 and the network entity 105 may communicate in accordance with receiving the primary synchronization signal and the physical broadcast channel transmission associated with the primary synchronization signal.

Additionally, or alternatively, the UE 115 may receive a power boost symbol prior to receiving a primary synchronization signal, the power boost symbol spanning a physical resource block in a synchronization signal block bandwidth. The UE 115 may then receive the primary synchronization signal and a secondary synchronization signal based on the power boost symbol, and may communicate with the network entity 105 in accordance with receiving the primary synchronization signal and the secondary synchronization signal.

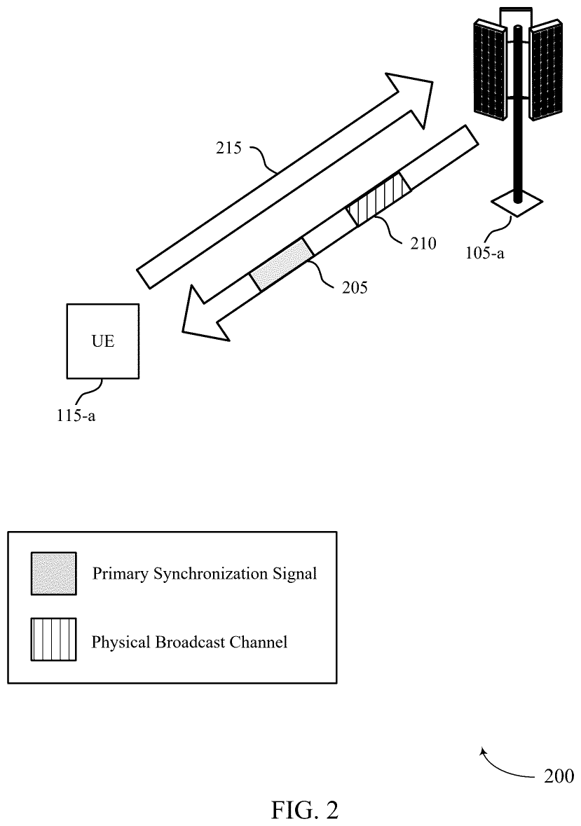

FIG. 2 shows an example of a wireless communications system 200 that supports cell presence detection enhancement in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described with reference to FIG. 1.

As depicted herein, a UE 115-a may detect a presence of a cell based on a synchronization signal block energy pattern. The UE 115-a may perform a primary synchronization signal correlation for each potential synchronization signal block candidate based on energy detection. One or more aspects depicted herein may be implemented to reduce a probability of false alarm rate and miss-detection rate, and to improve one or more cell detection parameters. The one or more cell detection parameters may include a time from power on to decode the physical broadcast channel without combining (shallow scan) or with combining (deep scan) for a single cell across all frequencies (e.g., T_acq). In some cases, the one or more cell detection parameters may include energy from power on to decode the physical broadcast channel without combining (shallow scan) or with combining (deep scan) for a single cell across all frequencies (e.g., E_acq). In some cases, based on the one or more cell detection parameters, the UE 115-a may determine whether it is out of coverage and stop the scan if there is no cell coverage.

According to one or more aspects depicted herein, a network entity 105-a and the UE 115-a may communicate in accordance with a redesigned primary synchronization signal. For example, the UE 115-a may receive a primary synchronization signal 205 spanning a first set of resource blocks. The UE 115-a may then receive a physical broadcast channel transmission 210 associated with the primary synchronization signal 205. The physical broadcast channel transmission 210 may span a second set of resource blocks. In the example of the redesigned primary synchronization signal, a numerical quantity of the first set of resource blocks is the same as a numerical quantity of the second set of resource blocks. That is, the primary synchronization signal 205 may be redesigned to span the same quantity of resource blocks as the physical broadcast channel transmission 210.

In some cases, at least one resource block of the first set of resource blocks may be empty. For example, the primary synchronization signal 205 spanning 20 resource blocks may be designed in a way such that the 2nd and the 19th resource blocks are left empty. The UE 115-a may be able to detect a unique energy signature corresponding to the primary synchronization signal 205 based on at least one resource block of the first set of resource blocks being empty. The UE 115-a upon detecting the energy signature corresponding to the primary synchronization signal 205 may communicate with the network entity (via communication link 215) in accordance with receiving the primary synchronization signal 205 and the physical broadcast channel transmission 210.

According to one or more aspects depicted herein, the network entity 105-a and the UE 115-a may communicate in accordance with a power boost symbol. For instance, the UE 115-a may receive a power boost symbol prior to receiving the primary synchronization signal 205. In some cases, the power boost symbol may span a physical resource block in a synchronization signal block bandwidth. The UE 115-a may receive a set of tones associated with the power boost symbol in accordance with a sequence. In some cases, the tones of power boost symbol may be boosted by a factor of 10 or 13 dB relative to secondary synchronization signal tones.

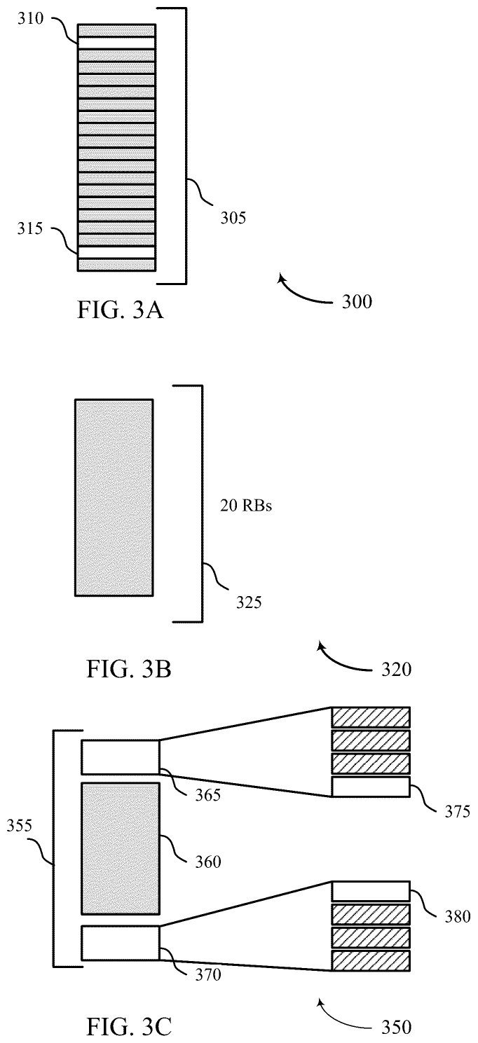

FIGS. 3A, 3B and 3C show examples of a signaling structure 300, a signaling structure 320, and a signaling structure 350 that support cell presence detection enhancement in accordance with one or more aspects of the present disclosure. The signaling structure 300, the signaling structure 320, and the signaling structure 350 may implement or may be implemented by aspects of the wireless communications system 100 and the wireless communications system 200, as described with reference to FIG. 1 and FIG. 2.

According to one or more aspects depicted herein, a UE 115 and a network entity 105 may communicate in accordance with a redesigned primary synchronization signal. As depicted in the example of FIG. 3A, a primary synchronization signal 305 may be (re-)designed to facilitate energy-based primary synchronization signal detection. For example, the primary synchronization signal 305 may span across 20 resource blocks. A primary synchronization signal sequence corresponding to the primary synchronization signal 305 may span 20 resource blocks with the 2nd and 19th resource blocks left empty as a more distinguishable energy pattern versus other signals (e.g., data signals or channel state information reference signals). For instance, the primary synchronization signal 305 may have resource block 310 and resource block 315 empty. In some examples, two out of the eight extended resource blocks (above and below the 12 resource blocks used for primary synchronization signal in a 20 resource block synchronization signal block structure) may be empty to distinguish over other downlink signals (e.g., channel state information reference signals).

In some examples, the UE 115 may detect an energy pattern corresponding to the primary synchronization signal 305. The energy pattern may indicate that at least one resource block of a first set of resource blocks (spanning 20 resource blocks) is empty. With the energy-based primary synchronization signal detection, the UE 115 may detect more raster points simultaneously compared with primary synchronization signal correlation-based detection for full frequency scan.

As depicted in the example of FIG. 3B, a primary synchronization signal 325 may be (re-)designed to facilitate energy-based primary synchronization signal detection. The primary synchronization signal 325 may span across 20 resource blocks. For instance, the primary synchronization signal false alarm or miss detection rate may be improved by using more resource compared with 127 tones. The primary synchronization signal 325 may include a primary synchronization signal sequence occupying all 20 resource blocks. This may increase primary synchronization signal correlation complexity, and may reduce physical broadcast channel payload, thereby increasing communication opportunity, since the remaining tones can be used for physical broadcast channel.

As depicted in the example of FIG. 3C, a UE 115 and a network entity 105 may communicate in accordance with a composite primary synchronization signal sequence 355. The UE 115 may receive a primary synchronization signal 360 mapped to a first subset of a first set of resource blocks. In some examples, the UE 115 may receive a synchronization signal block presence indicator mapped to a second subset of the first set of resource blocks (e.g., a subset 365 and a subset 370). In some examples, one or more tones located between the first subset of first set of resource blocks and the second subset of the first set of resource blocks may be empty. As depicted in the example of FIG. 3C, the resource block 375 and the resource block 380 may be empty.

Additionally, or alternatively, the UE 115 may receive a primary synchronization signal 360 mapped to a first subset of a first set of resource blocks, and may receive a secondary synchronization signal mapped to a second subset of the first set of resource blocks (e.g., a subset 365 and a subset 370). The primary synchronization signal 360 and the secondary synchronization signal may be FDM-ed. In some examples, one or more tones located between the first subset of first set of resource blocks and the second subset of the first set of resource blocks may be empty. As depicted in the example of FIG. 3C, the resource block 375 and the resource block 380 may be empty.

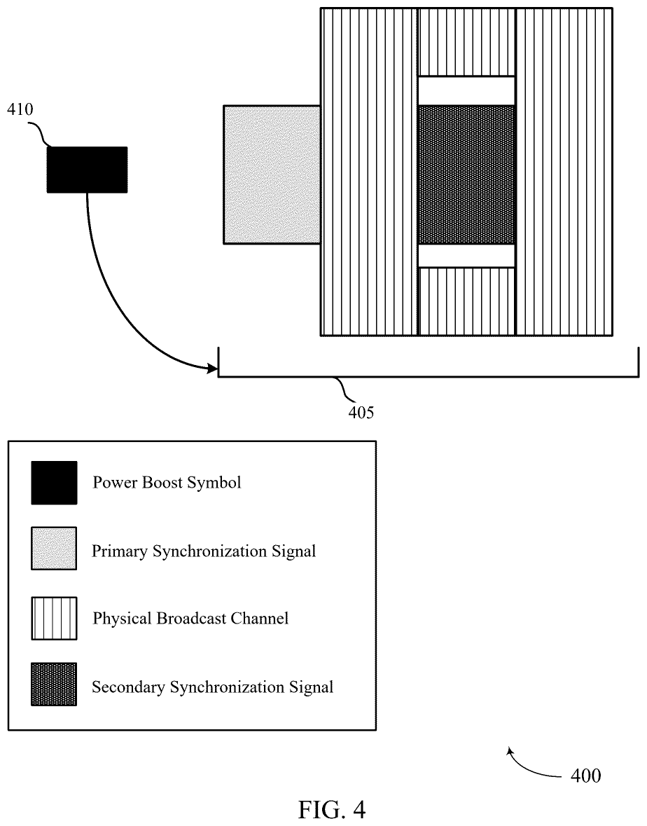

FIG. 4 shows an example of a signaling structure 400 that supports cell presence detection enhancement in accordance with one or more aspects of the present disclosure. The signaling structure 400 may implement or may be implemented by aspects of the wireless communications system 100 and the wireless communications system 200, as described with reference to FIG. 1 and FIG. 2.

According to one or more aspects depicted herein, a UE 115 and a network entity 105 may communicate in accordance with a synchronization signal block structure 405. The synchronization signal block structure 405 may include a primary synchronization signal, a physical broadcast channel transmission and a secondary synchronization signal. The UE 115 may use a power boost symbol 410 for cell presence detection. For instance, the UE 115 may receive a power boost symbol 410 prior to receiving a primary synchronization signal, the power boost symbol 410 spanning a physical resource block in a synchronization signal block bandwidth. In some cases, the power boost symbol 410 may occupy 1 OFDM symbol and/or 1 physical resource block within the synchronization signal block bandwidth. The tones of the power boost symbol 410 may boosted by a factor (e.g., 10 or 13 dB) relative to secondary synchronization signal tones. In some cases, the tones of the power boost symbol 410 may be transmitted with one predefined sequence (e.g., low peak to average power ratio computer generated sequence). In some cases, the remaining physical resource blocks within the synchronization signal block bandwidth may be left empty on the power boost symbol 410.

In some cases, the UE 115 may detect a correlation between a received energy of one or more tones associated with the power boost symbol and an expected energy associated with the power boost symbol. In some cases, receiving the power boost symbol 410 may be based on detecting the correlation. For instance, the UE 115 may detect the power boost symbol 410 by checking correlation energy of received tones on expected resource block of the power boost symbol 410.

As detecting power boost symbol may not be part of a fine granularity timing synchronization, the UE 115 may run the power boost symbol 410 detection with a rough timing step (e.g., 1 OFDM symbol or half OFDM symbol). In some cases, the UE 115 may run multiple power boost symbol 410 detections in parallel over multiple synchronization raster candidates over received bandwidth. For example, the UE 115 may run detection for the power boost symbol 410 for all synchronization raster candidates within 100 MHz or 200 MHz bandwidth in parallel. Once the UE 115 detects the power boost symbol 410 on a synchronization raster, the UE 115 may identify that there is a cell and may further pursue cell detection based on the synchronization signal block structure 405 including a primary synchronization signal, a physical broadcast channel transmission and a secondary synchronization signal. In some cases, the UE 115 may perform frequency hopping within a synchronization signal block bandwidth as a counter measure for frequency selective fading.

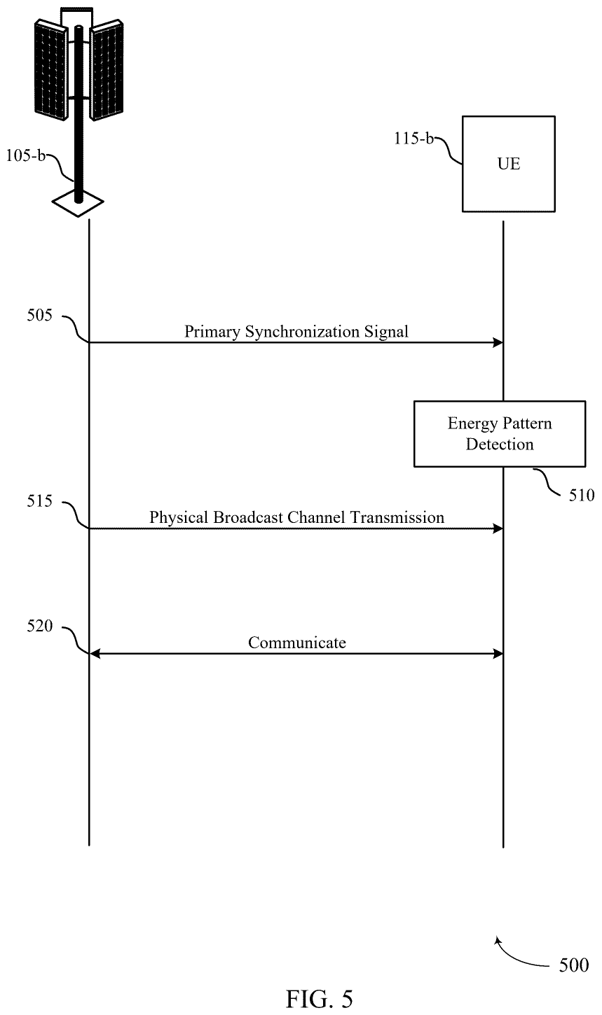

FIG. 5 shows an example of a process flow 500 that supports cell presence detection enhancement in accordance with one or more aspects of the present disclosure. The process flow 500 includes a UE 115-b and a network entity 105-b, which may be examples of the corresponding devices as described with respect to FIGS. 1 and 2. In the following description of the process flow 500, the operations between the UE 115-b and the network entity 105-b may be performed in a different order than the example order shown. Some operations may also be omitted from the process flow 500, and other operations may be added to the process flow 500. Further, although some operations or signaling may be shown to occur at different times for discussion purposes, these operations may actually occur at the same time.

At 505, the UE 115-b may receive, from the network entity 105-b, a primary synchronization signal spanning a first set of resource blocks. The first set of resource blocks may include 20 resource blocks.

In some cases, the UE 115-b may receive the primary synchronization signal mapped to a first subset of the first set of resource blocks and a synchronization signal block presence indicator mapped to a second subset of the first set of resource blocks. Additionally, or alternatively, the UE 115-b may receive the primary synchronization signal mapped to a first subset of the first set of resource blocks and a secondary synchronization signal mapped to a second subset of the first set of resource blocks. In some examples, one or more tones located between the first subset of first set of resource blocks and the second subset of the first set of resource blocks may be empty.

At 510, the UE 115-b may detect an energy pattern corresponding to the primary synchronization signal. In some cases, the energy pattern indicates that at least one resource block of the first set of resource blocks is empty.

At 515, the UE 115-b may receive, from the network entity 105-b, a physical broadcast channel transmission associated with the primary synchronization signal, the physical broadcast channel transmission spanning a second set of resource blocks. In some cases, a numerical quantity of the first set of resource blocks may be same as a numerical quantity of the second set of resource blocks.

At 520, the UE 115-b may communicate with the network entity 105-b in accordance with receiving the primary synchronization signal and the physical broadcast channel transmission associated with the primary synchronization signal.

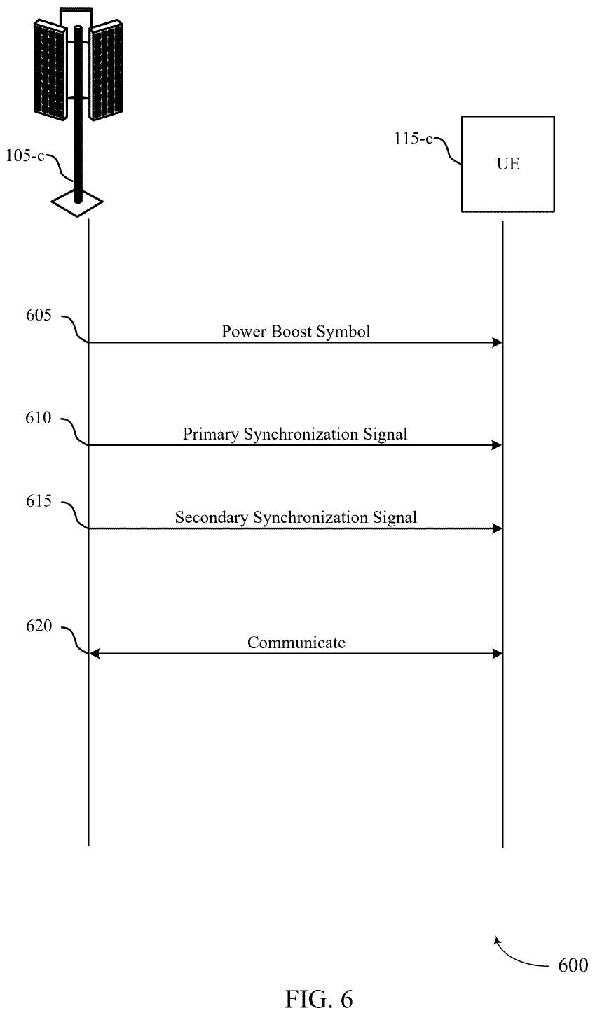

FIG. 6 shows an example of a process flow 600 that supports cell presence detection enhancement in accordance with one or more aspects of the present disclosure. The process flow 600 includes a UE 115-c and a network entity 105-c, which may be examples of the corresponding devices as described with respect to FIGS. 1 and 2. In the following description of the process flow 600, the operations between the UE 115-c and the network entity 105-c may be performed in a different order than the example order shown. Some operations may also be omitted from the process flow 600, and other operations may be added to the process flow 600. Further, although some operations or signaling may be shown to occur at different times for discussion purposes, these operations may actually occur at the same time.

At 605, the UE 115-c may receive, from the network entity 105-c, a power boost symbol prior to receiving a primary synchronization signal, the power boost symbol spanning a physical resource block in a synchronization signal block bandwidth.

In some examples, the UE 115-c may detect a correlation between a received energy of one or more tones associated with power boost symbol and an expected energy associated with the power boost symbol.

At 610, the UE 115-c may receive, from the network entity 105-c, the primary synchronization signal based on the power boost symbol. At 615, the UE 115-c may receive, from the network entity 105-c, the secondary synchronization signal based on the power boost symbol.

At 620, the UE 115-c may communicate with the network entity 105-c in accordance with receiving the primary synchronization signal and the secondary synchronization signal.

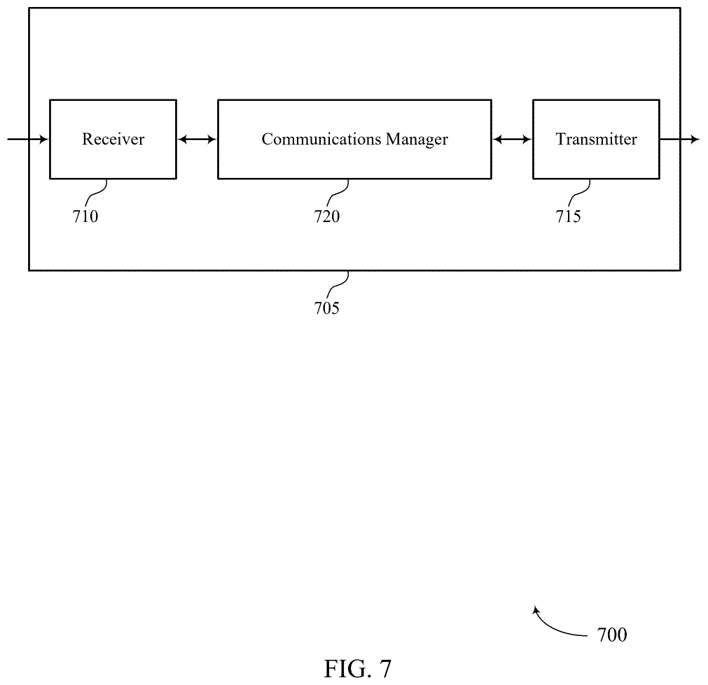

FIG. 7 shows a block diagram 700 of a device 705 that supports cell presence detection enhancement in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to cell presence detection enhancement). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cell presence detection enhancement). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of cell presence detection enhancement as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a primary synchronization signal spanning a first set of multiple resource blocks. The communications manager 720 is capable of, configured to, or operable to support a means for receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The communications manager 720 is capable of, configured to, or operable to support a means for communicating with a network entity in accordance with receiving the primary synchronization signal and the physical broadcast channel transmission associated with the primary synchronization signal.

Additionally, or alternatively, the communications manager 720 may support wireless communications in accordance with examples as disclosed herein. For example, the communications manager 720 is capable of, configured to, or operable to support a means for receiving a power boost symbol prior to receiving a primary synchronization signal, the power boost symbol spanning a physical resource block in a synchronization signal block bandwidth. The communications manager 720 is capable of, configured to, or operable to support a means for receiving the primary synchronization signal and a secondary synchronization signal based on the power boost symbol. The communications manager 720 is capable of, configured to, or operable to support a means for communicating with a network entity in accordance with receiving the primary synchronization signal and the secondary synchronization signal.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

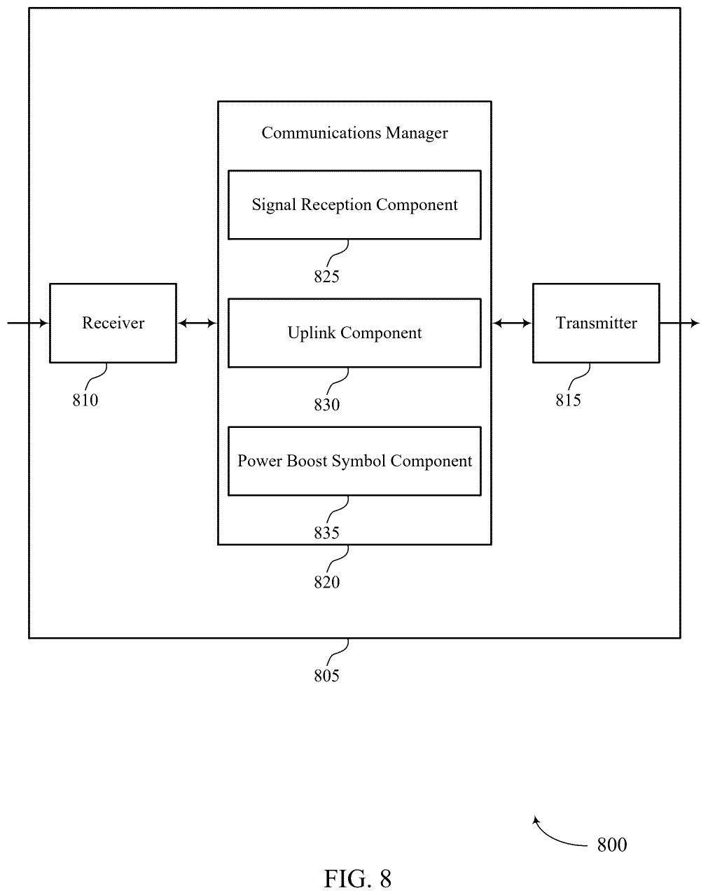

FIG. 8 shows a block diagram 800 of a device 805 that supports cell presence detection enhancement in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to cell presence detection enhancement). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cell presence detection enhancement). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of cell presence detection enhancement as described herein. For example, the communications manager 820 may include a signal reception component 825, an uplink component 830, a power boost symbol component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The signal reception component 825 is capable of, configured to, or operable to support a means for receiving a primary synchronization signal spanning a first set of multiple resource blocks. The signal reception component 825 is capable of, configured to, or operable to support a means for receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The uplink component 830 is capable of, configured to, or operable to support a means for communicating with a network entity in accordance with receiving the primary synchronization signal and the physical broadcast channel transmission associated with the primary synchronization signal.

Additionally, or alternatively, the communications manager 820 may support wireless communications in accordance with examples as disclosed herein. The power boost symbol component 835 is capable of, configured to, or operable to support a means for receiving a power boost symbol prior to receiving a primary synchronization signal, the power boost symbol spanning a physical resource block in a synchronization signal block bandwidth. The signal reception component 825 is capable of, configured to, or operable to support a means for receiving the primary synchronization signal and a secondary synchronization signal based on the power boost symbol. The uplink component 830 is capable of, configured to, or operable to support a means for communicating with a network entity in accordance with receiving the primary synchronization signal and the secondary synchronization signal.

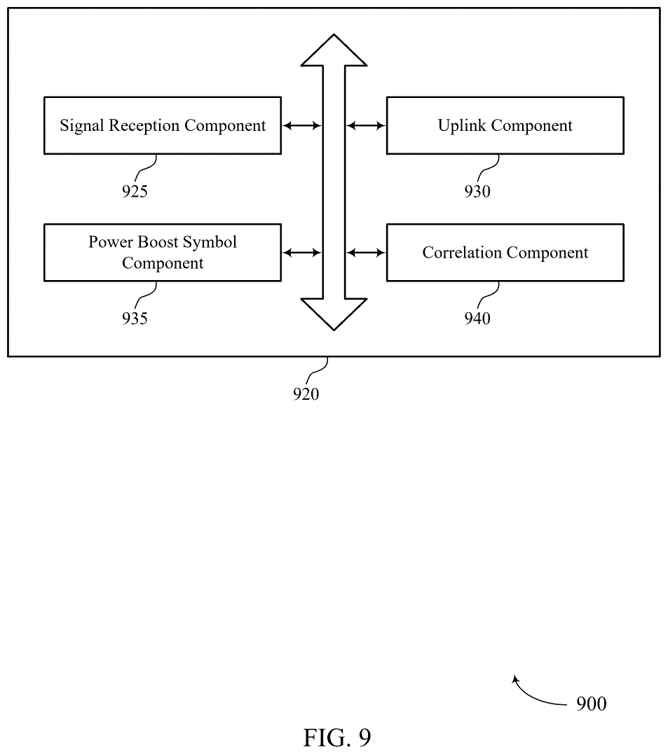

FIG. 9 shows a block diagram 900 of a communications manager 920 that supports cell presence detection enhancement in accordance with one or more aspects of the present disclosure. The communications manager 920 may be an example of aspects of a communications manager 720, a communications manager 820, or both, as described herein. The communications manager 920, or various components thereof, may be an example of means for performing various aspects of cell presence detection enhancement as described herein. For example, the communications manager 920 may include a signal reception component 925, an uplink component 930, a power boost symbol component 935, a correlation component 940, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The signal reception component 925 is capable of, configured to, or operable to support a means for receiving a primary synchronization signal spanning a first set of multiple resource blocks. In some examples, the signal reception component 925 is capable of, configured to, or operable to support a means for receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The uplink component 930 is capable of, configured to, or operable to support a means for communicating with a network entity in accordance with receiving the primary synchronization signal and the physical broadcast channel transmission associated with the primary synchronization signal. In some examples, at least one resource block of the first set of multiple resource blocks is empty.

In some examples, to support receiving the primary synchronization signal, the signal reception component 925 is capable of, configured to, or operable to support a means for receiving the primary synchronization signal mapped to a first subset of the first set of multiple resource blocks. In some examples, to support receiving the primary synchronization signal, the signal reception component 925 is capable of, configured to, or operable to support a means for receiving a synchronization signal block presence indicator mapped to a second subset of the first set of multiple resource blocks. In some examples, one or more tones located between the first subset of first set of multiple resource blocks and the second subset of the first set of multiple resource blocks are empty.

In some examples, to support receiving the primary synchronization signal, the signal reception component 925 is capable of, configured to, or operable to support a means for receiving the primary synchronization signal mapped to a first subset of the first set of multiple resource blocks. In some examples, to support receiving the primary synchronization signal, the signal reception component 925 is capable of, configured to, or operable to support a means for receiving a secondary synchronization signal mapped to a second subset of the first set of multiple resource blocks. In some examples, one or more tones located between the first subset of first set of multiple resource blocks and the second subset of the first set of multiple resource blocks are empty.

In some examples, to support receiving the primary synchronization signal, the signal reception component 925 is capable of, configured to, or operable to support a means for receiving a primary synchronization signal burst including a first primary synchronization signal and a second primary synchronization signal, where each of the first primary synchronization signal and the second primary synchronization signal span the first set of multiple resource blocks.

In some examples, to support receiving the primary synchronization signal, the signal reception component 925 is capable of, configured to, or operable to support a means for detecting an energy pattern corresponding to the primary synchronization signal, where the energy pattern indicates that at least one resource block of the first set of multiple resource blocks is empty. In some examples, the numerical quantity of the first set of multiple resource blocks includes twenty resource blocks.

Additionally, or alternatively, the communications manager 920 may support wireless communications in accordance with examples as disclosed herein. The power boost symbol component 935 is capable of, configured to, or operable to support a means for receiving a power boost symbol prior to receiving a primary synchronization signal, the power boost symbol spanning a physical resource block in a synchronization signal block bandwidth. In some examples, the signal reception component 925 is capable of, configured to, or operable to support a means for receiving the primary synchronization signal and a secondary synchronization signal based on the power boost symbol. In some examples, the uplink component 930 is capable of, configured to, or operable to support a means for communicating with a network entity in accordance with receiving the primary synchronization signal and the secondary synchronization signal.

In some examples, to support receiving the power boost symbol, the power boost symbol component 935 is capable of, configured to, or operable to support a means for receiving a set of tones associated with the power boost symbol in accordance with a sequence. In some examples, the sequence includes a low peak to average power ratio computer generated sequence.

In some examples, the correlation component 940 is capable of, configured to, or operable to support a means for detecting a correlation between a received energy of one or more tones associated with the power boost symbol and an expected energy associated with the power boost symbol, where receiving the power boost symbol is based on detecting the correlation.

In some examples, at least one tone associated with the power boost symbol is boosted by a factor relative to at least one tone associated with the secondary synchronization signal. In some examples, a set of remaining physical resource blocks in the synchronization signal block bandwidth is empty.

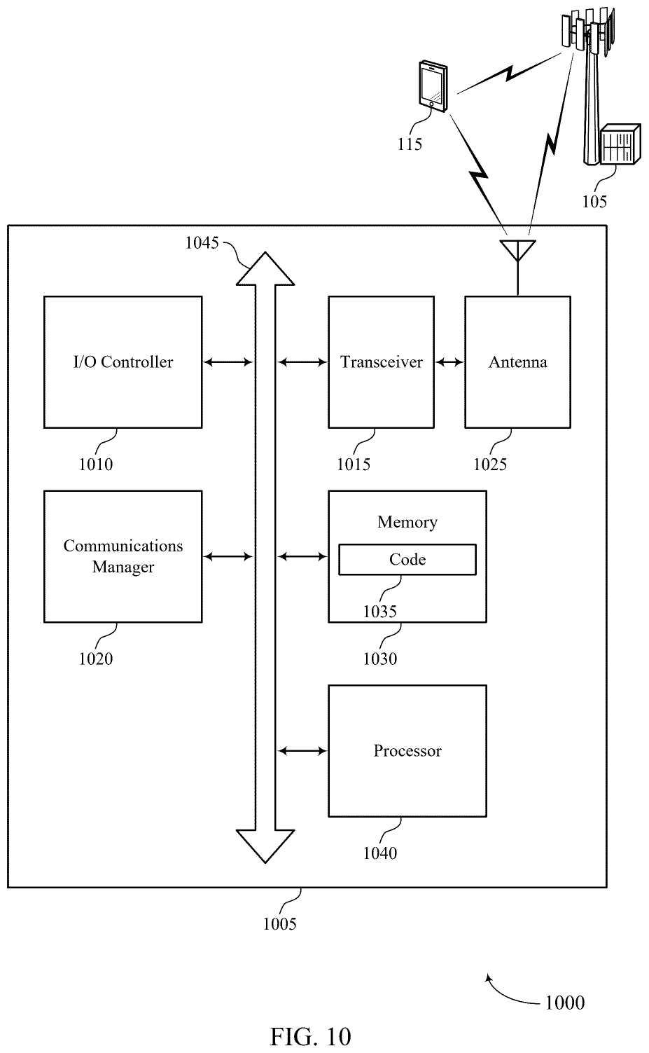

FIG. 10 shows a diagram of a system 1000 including a device 1005 that supports cell presence detection enhancement in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting cell presence detection enhancement). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a primary synchronization signal spanning a first set of multiple resource blocks. The communications manager 1020 is capable of, configured to, or operable to support a means for receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The communications manager 1020 is capable of, configured to, or operable to support a means for communicating with a network entity in accordance with receiving the primary synchronization signal and the physical broadcast channel transmission associated with the primary synchronization signal.

Additionally, or alternatively, the communications manager 1020 may support wireless communications in accordance with examples as disclosed herein. For example, the communications manager 1020 is capable of, configured to, or operable to support a means for receiving a power boost symbol prior to receiving a primary synchronization signal, the power boost symbol spanning a physical resource block in a synchronization signal block bandwidth. The communications manager 1020 is capable of, configured to, or operable to support a means for receiving the primary synchronization signal and a secondary synchronization signal based on the power boost symbol. The communications manager 1020 is capable of, configured to, or operable to support a means for communicating with a network entity in accordance with receiving the primary synchronization signal and the secondary synchronization signal.

By including or configuring the communications manager 1020 in accordance with examples as described herein, the device 1005 may support techniques for improved communication reliability, reduced latency, improved user experience related to reduced processing, reduced power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of cell presence detection enhancement as described herein, or the at least one processor 1040 and the at least one memory 1030 may be otherwise configured to, individually or collectively, perform or support such operations.

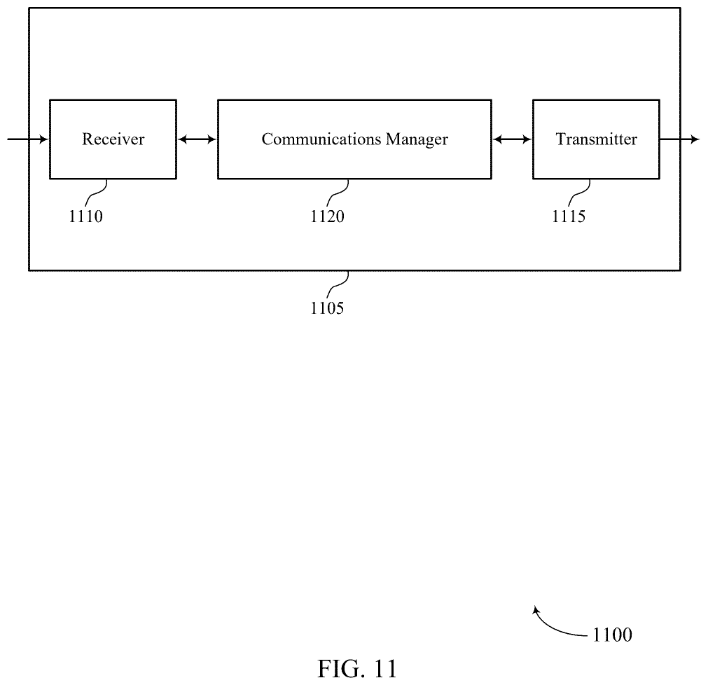

FIG. 11 shows a block diagram 1100 of a device 1105 that supports cell presence detection enhancement in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of cell presence detection enhancement as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting a primary synchronization signal spanning a first set of multiple resource blocks. The communications manager 1120 is capable of, configured to, or operable to support a means for outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The communications manager 1120 is capable of, configured to, or operable to support a means for communicating with a UE in accordance with outputting the primary synchronization signal and the physical broadcast channel transmission associated with the primary synchronization signal.

Additionally, or alternatively, the communications manager 1120 may support wireless communications in accordance with examples as disclosed herein. For example, the communications manager 1120 is capable of, configured to, or operable to support a means for outputting a power boost symbol prior to outputting a primary synchronization signal, the power boost symbol spanning a physical resource block in a synchronization signal block bandwidth. The communications manager 1120 is capable of, configured to, or operable to support a means for outputting the primary synchronization signal and a secondary synchronization signal based on the power boost symbol. The communications manager 1120 is capable of, configured to, or operable to support a means for communicating with a UE in accordance with outputting the primary synchronization signal and the secondary synchronization signal.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

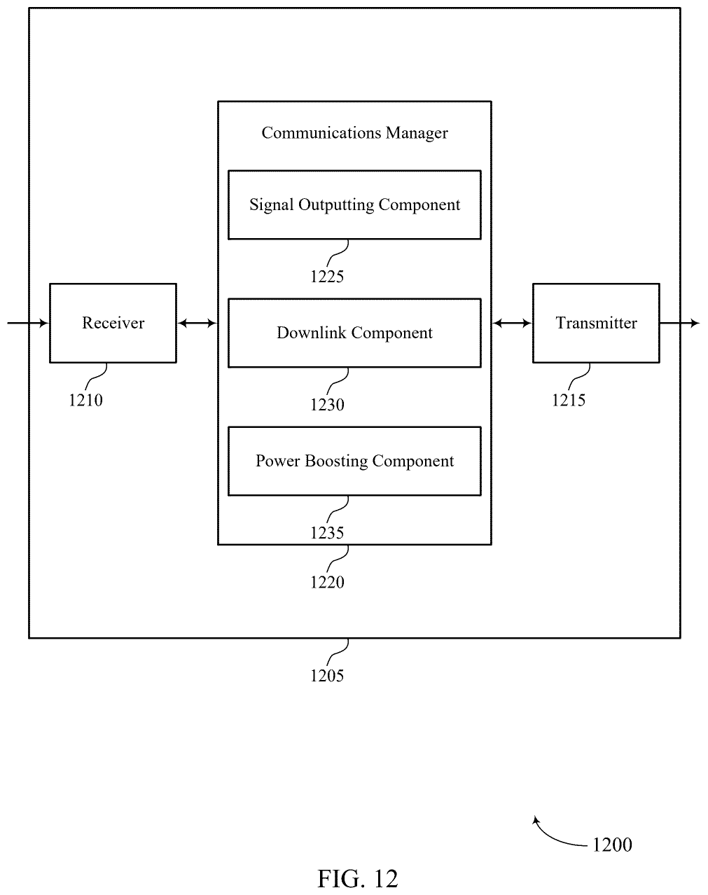

FIG. 12 shows a block diagram 1200 of a device 1205 that supports cell presence detection enhancement in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of cell presence detection enhancement as described herein. For example, the communications manager 1220 may include a signal outputting component 1225, a downlink component 1230, a power boosting component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The signal outputting component 1225 is capable of, configured to, or operable to support a means for outputting a primary synchronization signal spanning a first set of multiple resource blocks. The signal outputting component 1225 is capable of, configured to, or operable to support a means for outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The downlink component 1230 is capable of, configured to, or operable to support a means for communicating with a UE in accordance with outputting the primary synchronization signal and the physical broadcast channel transmission associated with the primary synchronization signal.

Additionally, or alternatively, the communications manager 1220 may support wireless communications in accordance with examples as disclosed herein. The power boosting component 1235 is capable of, configured to, or operable to support a means for outputting a power boost symbol prior to outputting a primary synchronization signal, the power boost symbol spanning a physical resource block in a synchronization signal block bandwidth. The signal outputting component 1225 is capable of, configured to, or operable to support a means for outputting the primary synchronization signal and a secondary synchronization signal based on the power boost symbol. The downlink component 1230 is capable of, configured to, or operable to support a means for communicating with a UE in accordance with outputting the primary synchronization signal and the secondary synchronization signal.

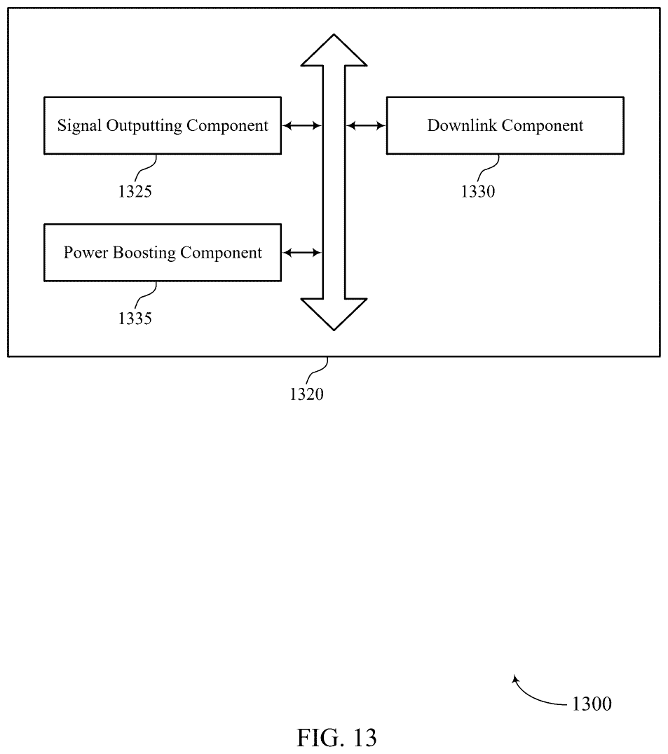

FIG. 13 shows a block diagram 1300 of a communications manager 1320 that supports cell presence detection enhancement in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of cell presence detection enhancement as described herein. For example, the communications manager 1320 may include a signal outputting component 1325, a downlink component 1330, a power boosting component 1335, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The signal outputting component 1325 is capable of, configured to, or operable to support a means for outputting a primary synchronization signal spanning a first set of multiple resource blocks. In some examples, the signal outputting component 1325 is capable of, configured to, or operable to support a means for outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The downlink component 1330 is capable of, configured to, or operable to support a means for communicating with a UE in accordance with outputting the primary synchronization signal and the physical broadcast channel transmission associated with the primary synchronization signal. In some examples, at least one resource block of the first set of multiple resource blocks is empty.

In some examples, to support outputting the primary synchronization signal, the signal outputting component 1325 is capable of, configured to, or operable to support a means for outputting the primary synchronization signal mapped to a first subset of the first set of multiple resource blocks. In some examples, to support outputting the primary synchronization signal, the signal outputting component 1325 is capable of, configured to, or operable to support a means for outputting a synchronization signal block presence indicator mapped to a second subset of the first set of multiple resource blocks. In some examples, one or more tones located between the first subset of first set of multiple resource blocks and the second subset of the first set of multiple resource blocks are empty.

In some examples, to support outputting the primary synchronization signal, the signal outputting component 1325 is capable of, configured to, or operable to support a means for outputting the primary synchronization signal mapped to a first subset of the first set of multiple resource blocks. In some examples, to support outputting the primary synchronization signal, the signal outputting component 1325 is capable of, configured to, or operable to support a means for outputting a secondary synchronization signal mapped to a second subset of the first set of multiple resource blocks. In some examples, one or more tones located between the first subset of first set of multiple resource blocks and the second subset of the first set of multiple resource blocks are empty.

In some examples, to support outputting the primary synchronization signal, the signal outputting component 1325 is capable of, configured to, or operable to support a means for outputting a primary synchronization signal burst including a first primary synchronization signal and a second primary synchronization signal, where each of the first primary synchronization signal and the second primary synchronization signal span the first set of multiple resource blocks.

In some examples, to support outputting the primary synchronization signal, the signal outputting component 1325 is capable of, configured to, or operable to support a means for outputting the primary synchronization signal in accordance with an energy pattern, where the energy pattern indicates that at least one resource block of the first set of multiple resource blocks is empty. In some examples, the numerical quantity of the first set of multiple resource blocks includes twenty resource blocks.

Additionally, or alternatively, the communications manager 1320 may support wireless communications in accordance with examples as disclosed herein. The power boosting component 1335 is capable of, configured to, or operable to support a means for outputting a power boost symbol prior to outputting a primary synchronization signal, the power boost symbol spanning a physical resource block in a synchronization signal block bandwidth. In some examples, the signal outputting component 1325 is capable of, configured to, or operable to support a means for outputting the primary synchronization signal and a secondary synchronization signal based on the power boost symbol. In some examples, the downlink component 1330 is capable of, configured to, or operable to support a means for communicating with a UE in accordance with outputting the primary synchronization signal and the secondary synchronization signal.

In some examples, to support outputting the power boost symbol, the power boosting component 1335 is capable of, configured to, or operable to support a means for outputting a set of tones associated with the power boost symbol in accordance with a sequence.

In some examples, the sequence includes a low peak to average power ratio computer generated sequence. In some examples, an energy of one or more tones associated with the power boost symbol has a correlation with an expected energy associated with the power boost symbol. In some examples, outputting the power boost symbol is based on the correlation.

In some examples, at least one tone associated with the power boost symbol is boosted by a factor relative to at least one tone associated with the secondary synchronization signal. In some examples, a set of remaining physical resource blocks in the synchronization signal block bandwidth is empty.

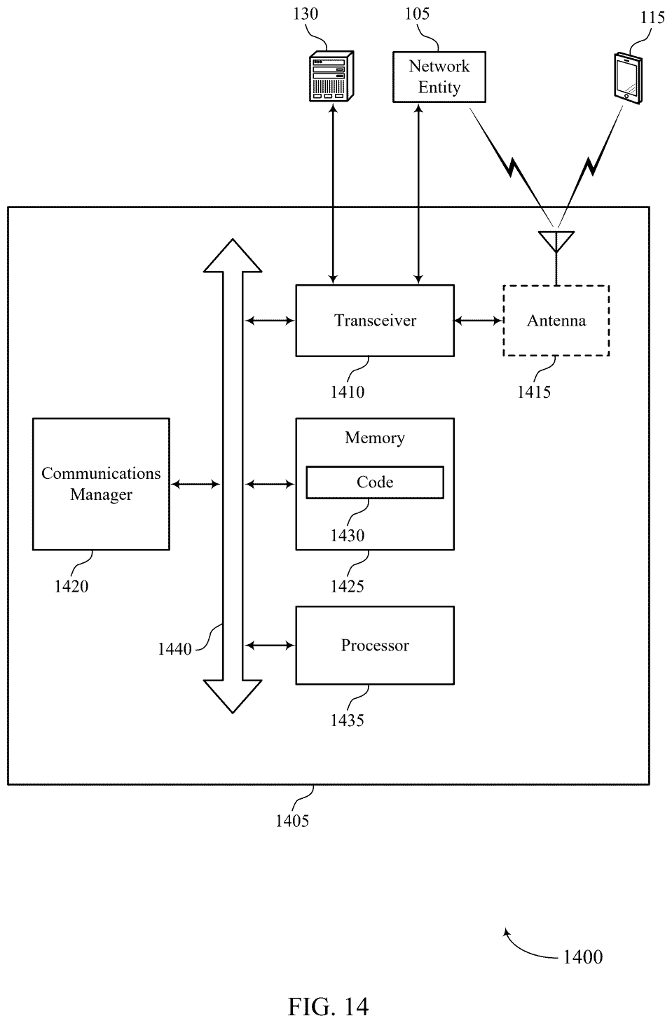

FIG. 14 shows a diagram of a system 1400 including a device 1405 that supports cell presence detection enhancement in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting cell presence detection enhancement). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting a primary synchronization signal spanning a first set of multiple resource blocks. The communications manager 1420 is capable of, configured to, or operable to support a means for outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The communications manager 1420 is capable of, configured to, or operable to support a means for communicating with a UE in accordance with outputting the primary synchronization signal and the physical broadcast channel transmission associated with the primary synchronization signal.

Additionally, or alternatively, the communications manager 1420 may support wireless communications in accordance with examples as disclosed herein. For example, the communications manager 1420 is capable of, configured to, or operable to support a means for outputting a power boost symbol prior to outputting a primary synchronization signal, the power boost symbol spanning a physical resource block in a synchronization signal block bandwidth. The communications manager 1420 is capable of, configured to, or operable to support a means for outputting the primary synchronization signal and a secondary synchronization signal based on the power boost symbol. The communications manager 1420 is capable of, configured to, or operable to support a means for communicating with a UE in accordance with outputting the primary synchronization signal and the secondary synchronization signal.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of cell presence detection enhancement as described herein, or the at least one processor 1435 and the at least one memory 1425 may be otherwise configured to, individually or collectively, perform or support such operations.

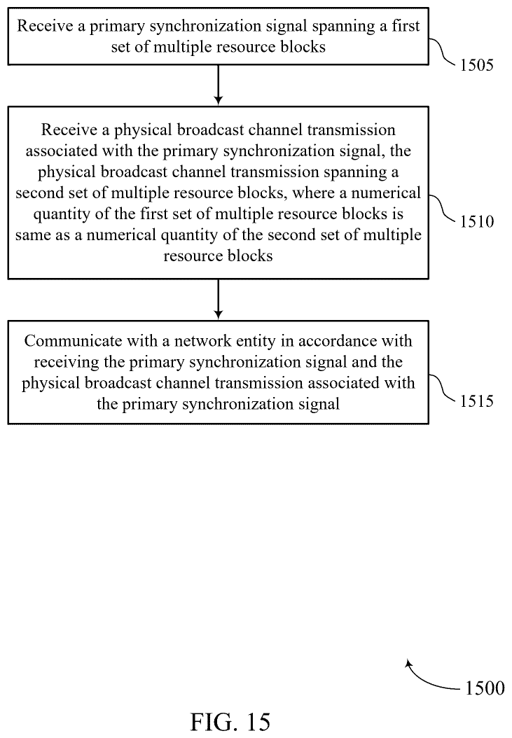

FIG. 15 shows a flowchart illustrating a method 1500 that supports cell presence detection enhancement in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a primary synchronization signal spanning a first set of multiple resource blocks. The operations of 1505 may be performed in accordance with examples as disclosed herein. In some examples, aspects of the operations of 1505 may be performed by a signal reception component 925 as described with reference to FIG. 9.

At 1510, the method may include receiving a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The operations of 1510 may be performed in accordance with examples as disclosed herein. In some examples, aspects of the operations of 1510 may be performed by a signal reception component 925 as described with reference to FIG. 9.

At 1515, the method may include communicating with a network entity in accordance with receiving the primary synchronization signal and the physical broadcast channel transmission associated with the primary synchronization signal. The operations of 1515 may be performed in accordance with examples as disclosed herein. In some examples, aspects of the operations of 1515 may be performed by an uplink component 930 as described with reference to FIG. 9.

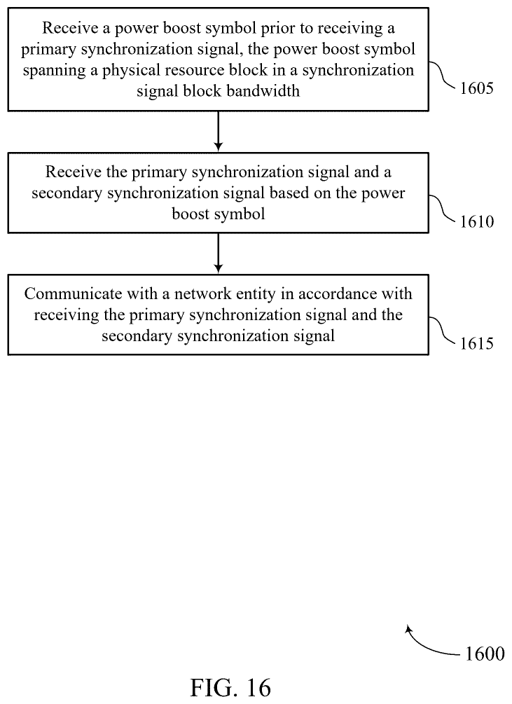

FIG. 16 shows a flowchart illustrating a method 1600 that supports cell presence detection enhancement in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a power boost symbol prior to receiving a primary synchronization signal, the power boost symbol spanning a physical resource block in a synchronization signal block bandwidth. The operations of 1605 may be performed in accordance with examples as disclosed herein. In some examples, aspects of the operations of 1605 may be performed by a power boost symbol component 935 as described with reference to FIG. 9.

At 1610, the method may include receiving the primary synchronization signal and a secondary synchronization signal based on the power boost symbol. The operations of 1610 may be performed in accordance with examples as disclosed herein. In some examples, aspects of the operations of 1610 may be performed by a signal reception component 925 as described with reference to FIG. 9.

At 1615, the method may include communicating with a network entity in accordance with receiving the primary synchronization signal and the secondary synchronization signal. The operations of 1615 may be performed in accordance with examples as disclosed herein. In some examples, aspects of the operations of 1615 may be performed by an uplink component 930 as described with reference to FIG. 9.

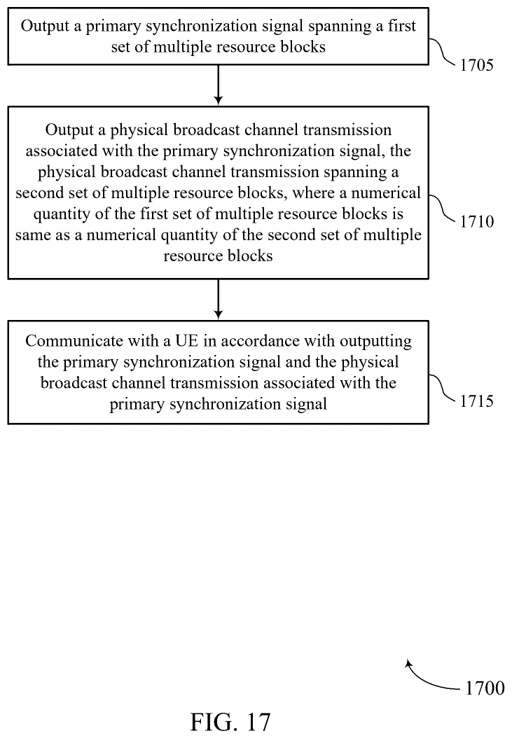

FIG. 17 shows a flowchart illustrating a method 1700 that supports cell presence detection enhancement in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting a primary synchronization signal spanning a first set of multiple resource blocks. The operations of 1705 may be performed in accordance with examples as disclosed herein. In some examples, aspects of the operations of 1705 may be performed by a signal outputting component 1325 as described with reference to FIG. 13.

At 1710, the method may include outputting a physical broadcast channel transmission associated with the primary synchronization signal, the physical broadcast channel transmission spanning a second set of multiple resource blocks, where a numerical quantity of the first set of multiple resource blocks is same as a numerical quantity of the second set of multiple resource blocks. The operations of 1710 may be performed in accordance with examples as disclosed herein. In some examples, aspects of the operations of 1710 may be performed by a signal outputting component 1325 as described with reference to FIG. 13.

At 1715, the method may include communicating with a UE in accordance with outputting the primary synchronization signal and the physical broadcast channel transmission associated with the primary synchronization signal. The operations of 1715 may be performed in accordance with examples as disclosed herein. In some examples, aspects of the operations of 1715 may be performed by a downlink component 1330 as described with reference to FIG. 13.

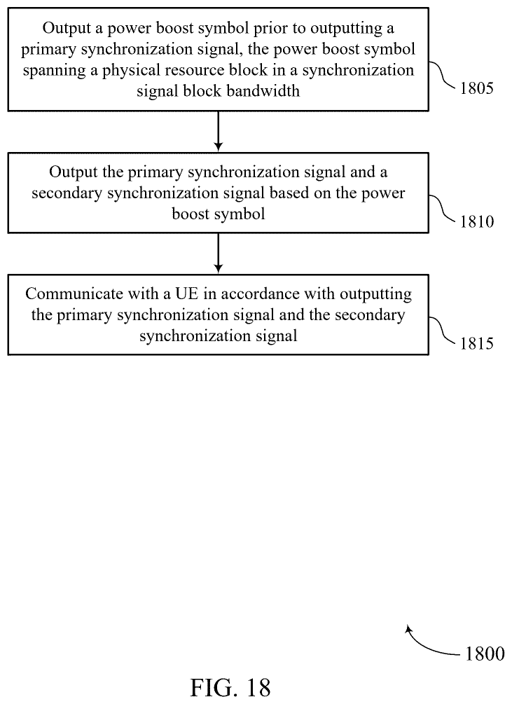

FIG. 18 shows a flowchart illustrating a method 1800 that supports cell presence detection enhancement in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting a power boost symbol prior to outputting a primary synchronization signal, the power boost symbol spanning a physical resource block in a synchronization signal block bandwidth. The operations of 1805 may be performed in accordance with examples as disclosed herein. In some examples, aspects of the operations of 1805 may be performed by a power boosting component 1335 as described with reference to FIG. 13.

At 1810, the method may include outputting the primary synchronization signal and a secondary synchronization signal based on the power boost symbol. The operations of 1810 may be performed in accordance with examples as disclosed herein. In some examples, aspects of the operations of 1810 may be performed by a signal outputting component 1325 as described with reference to FIG. 13.

At 1815, the method may include communicating with a UE in accordance with outputting the primary synchronization signal and the secondary synchronization signal. The operations of 1815 may be performed in accordance with examples as disclosed herein. In some examples, aspects of the operations of 1815 may be performed by a downlink component 1330 as described with reference to FIG. 13.

The following provides an overview of aspects of the present disclosure:
Aspect 1: A method for wireless communications at a UE, comprising: receiving a primary synchronization signal spanning a first plurality of resource blocks; receiving a physical broadcast channel transmission associated with the primary synchronization signal, the physical broadcast channel transmission spanning a second plurality of resource blocks, wherein a numerical quantity of the first plurality of resource blocks is same as a numerical quantity of the second plurality of resource blocks; and communicating with a network entity in accordance with receiving the primary synchronization signal and the physical broadcast channel transmission associated with the primary synchronization signal.
Aspect 2: The method of aspect 1, wherein at least one resource block of the first plurality of resource blocks is empty.
Aspect 3: The method of any of aspects 1 through 2, wherein receiving the primary synchronization signal further comprises: receiving the primary synchronization signal mapped to a first subset of the first plurality of resource blocks; and receiving a synchronization signal block presence indicator mapped to a second subset of the first plurality of resource blocks.
Aspect 4: The method of aspect 3, wherein one or more tones located between the first subset of first plurality of resource blocks and the second subset of the first plurality of resource blocks are empty.
Aspect 5: The method of any of aspects 1 through 4, wherein receiving the primary synchronization signal further comprises: receiving the primary synchronization signal mapped to a first subset of the first plurality of resource blocks; and receiving a secondary synchronization signal mapped to a second subset of the first plurality of resource blocks.
Aspect 6: The method of aspect 5, wherein one or more tones located between the first subset of first plurality of resource blocks and the second subset of the first plurality of resource blocks are empty.
Aspect 7: The method of any of aspects 1 through 6, wherein receiving the primary synchronization signal further comprises: receiving a primary synchronization signal burst comprising a first primary synchronization signal and a second primary synchronization signal, wherein each of the first primary synchronization signal and the second primary synchronization signal span the first plurality of resource blocks.
Aspect 8: The method of any of aspects 1 through 7, wherein receiving the primary synchronization signal further comprises: detecting an energy pattern corresponding to the primary synchronization signal, wherein the energy pattern indicates that at least one resource block of the first plurality of resource blocks is empty.
Aspect 9: The method of any of aspects 1 through 8, wherein the numerical quantity of the first plurality of resource blocks comprises twenty resource blocks.
Aspect 10: A method for wireless communications at a UE, comprising: receiving a power boost symbol prior to receiving a primary synchronization signal, the power boost symbol spanning a physical resource block in a synchronization signal block bandwidth; receiving the primary synchronization signal and a secondary synchronization signal based at least in part on the power boost symbol; and communicating with a network entity in accordance with receiving the primary synchronization signal and the secondary synchronization signal.
Aspect 11: The method of aspect 10, wherein receiving the power boost symbol comprises: receiving a set of tones associated with the power boost symbol in accordance with a sequence.
Aspect 12: The method of aspect 11, wherein the sequence comprises a low peak to average power ratio computer generated sequence.
Aspect 13: The method of any of aspects 10 through 12, further comprising: detecting a correlation between a received energy of one or more tones associated with power boost symbol and an expected energy associated with the power boost symbol, wherein receiving the power boost symbol is based at least in part on detecting the correlation.
Aspect 14: The method of any of aspects 10 through 13, wherein at least one tone associated with the power boost symbol is boosted by a factor relative to at least one tone associated with the secondary synchronization signal.
Aspect 15: The method of any of aspects 10 through 14, wherein a set of remaining physical resource blocks in the synchronization signal block bandwidth is empty.
Aspect 16: A method for wireless communications at a network entity, comprising: outputting a primary synchronization signal spanning a first plurality of resource blocks; outputting a physical broadcast channel transmission associated with the primary synchronization signal, the physical broadcast channel transmission spanning a second plurality of resource blocks, wherein a numerical quantity of the first plurality of resource blocks is same as a numerical quantity of the second plurality of resource blocks; and communicating with a UE in accordance with outputting the primary synchronization signal and the physical broadcast channel transmission associated with the primary synchronization signal.
Aspect 17: The method of aspect 16, wherein at least one resource block of the first plurality of resource blocks is empty.
Aspect 18: The method of any of aspects 16 through 17, wherein outputting the primary synchronization signal further comprises: outputting the primary synchronization signal mapped to a first subset of the first plurality of resource blocks; and outputting a synchronization signal block presence indicator mapped to a second subset of the first plurality of resource blocks.
Aspect 19: The method of aspect 18, wherein one or more tones located between the first subset of first plurality of resource blocks and the second subset of the first plurality of resource blocks are empty.
Aspect 20: The method of any of aspects 16 through 19, wherein outputting the primary synchronization signal further comprises: outputting the primary synchronization signal mapped to a first subset of the first plurality of resource blocks; and outputting a secondary synchronization signal mapped to a second subset of the first plurality of resource blocks.
Aspect 21: The method of aspect 20, wherein one or more tones located between the first subset of first plurality of resource blocks and the second subset of the first plurality of resource blocks are empty.
Aspect 22: The method of any of aspects 16 through 21, wherein outputting the primary synchronization signal further comprises: outputting a primary synchronization signal burst comprising a first primary synchronization signal and a second primary synchronization signal, wherein each of the first primary synchronization signal and the second primary synchronization signal span the first plurality of resource blocks.
Aspect 23: The method of any of aspects 16 through 22, wherein outputting the primary synchronization signal further comprises: outputting the primary synchronization signal in accordance with an energy pattern, wherein the energy pattern indicates that at least one resource block of the first plurality of resource blocks is empty.
Aspect 24: The method of any of aspects 16 through 23, wherein the numerical quantity of the first plurality of resource blocks comprises twenty resource blocks.
Aspect 25: A method for wireless communications at a network entity, comprising: outputting a power boost symbol prior to outputting a primary synchronization signal, the power boost symbol spanning a physical resource block in a synchronization signal block bandwidth; outputting the primary synchronization signal and a secondary synchronization signal based at least in part on the power boost symbol; and communicating with a UE in accordance with outputting the primary synchronization signal and the secondary synchronization signal.
Aspect 26: The method of aspect 25, wherein outputting the power boost symbol comprises: outputting a set of tones associated with the power boost symbol in accordance with a sequence.
Aspect 27: The method of aspect 26, wherein the sequence comprises a low peak to average power ratio computer generated sequence.
Aspect 28: The method of any of aspects 25 through 27, wherein an energy of one or more tones associated with power boost symbol has a correlation with an expected energy associated with the power boost symbol, outputting the power boost symbol is based at least in part on the correlation.
Aspect 29: The method of any of aspects 25 through 28, wherein at least one tone associated with the power boost symbol is boosted by a factor relative to at least one tone associated with the secondary synchronization signal.
Aspect 30: The method of any of aspects 25 through 29, wherein a set of remaining physical resource blocks in the synchronization signal block bandwidth is empty.
Aspect 31: A UE for wireless communications, comprising one or more memories storing processor-executable code, and one or more processors coupled with the one or more memories and individually or collectively operable to execute the code to cause the UE to perform a method of any of aspects 1 through 9.
Aspect 32: A UE for wireless communications, comprising at least one means for performing a method of any of aspects 1 through 9.
Aspect 33: A non-transitory computer-readable medium storing code for wireless communications, the code comprising instructions executable by one or more processors to perform a method of any of aspects 1 through 9.
Aspect 34: A UE for wireless communications, comprising one or more memories storing processor-executable code, and one or more processors coupled with the one or more memories and individually or collectively operable to execute the code to cause the UE to perform a method of any of aspects 10 through 15.
Aspect 35: A UE for wireless communications, comprising at least one means for performing a method of any of aspects 10 through 15.
Aspect 36: A non-transitory computer-readable medium storing code for wireless communications, the code comprising instructions executable by one or more processors to perform a method of any of aspects 10 through 15.
Aspect 37: A network entity for wireless communications, comprising one or more memories storing processor-executable code, and one or more processors coupled with the one or more memories and individually or collectively operable to execute the code to cause the network entity to perform a method of any of aspects 16 through 24.
Aspect 38: A network entity for wireless communications, comprising at least one means for performing a method of any of aspects 16 through 24.
Aspect 39: A non-transitory computer-readable medium storing code for wireless communications, the code comprising instructions executable by one or more processors to perform a method of any of aspects 16 through 24.
Aspect 40: A network entity for wireless communications, comprising one or more memories storing processor-executable code, and one or more processors coupled with the one or more memories and individually or collectively operable to execute the code to cause the network entity to perform a method of any of aspects 25 through 30.
Aspect 41: A network entity for wireless communications, comprising at least one means for performing a method of any of aspects 25 through 30.
Aspect 42: A non-transitory computer-readable medium storing code for wireless communications, the code comprising instructions executable by one or more processors to perform a method of any of aspects 25 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a primary synchronization signal spanning a first plurality of resource blocks;
receive a physical broadcast channel transmission associated with the primary synchronization signal, the physical broadcast channel transmission spanning a second plurality of resource blocks, wherein a numerical quantity of the first plurality of resource blocks is same as a numerical quantity of the second plurality of resource blocks; and
communicate with a network entity in accordance with receiving the primary synchronization signal and the physical broadcast channel transmission associated with the primary synchronization signal.

2. The UE of claim 1, wherein at least one resource block of the first plurality of resource blocks is empty.

3. The UE of claim 1, wherein, to receive the primary synchronization signal, the one or more processors are individually or collectively further operable to execute the code to cause the UE to:
receive the primary synchronization signal mapped to a first subset of the first plurality of resource blocks; and
receive a synchronization signal block presence indicator mapped to a second subset of the first plurality of resource blocks.

4. The UE of claim 3, wherein one or more tones located between the first subset of first plurality of resource blocks and the second subset of the first plurality of resource blocks are empty.

5. The UE of claim 1, wherein, to receive the primary synchronization signal, the one or more processors are individually or collectively further operable to execute the code to cause the UE to:
receive the primary synchronization signal mapped to a first subset of the first plurality of resource blocks; and
receive a secondary synchronization signal mapped to a second subset of the first plurality of resource blocks.

6. The UE of claim 5, wherein one or more tones located between the first subset of first plurality of resource blocks and the second subset of the first plurality of resource blocks are empty.

7. The UE of claim 1, wherein, to receive the primary synchronization signal, the one or more processors are individually or collectively further operable to execute the code to cause the UE to:
receive a primary synchronization signal burst comprising a first primary synchronization signal and a second primary synchronization signal, wherein each of the first primary synchronization signal and the second primary synchronization signal span the first plurality of resource blocks.

8. The UE of claim 1, wherein, to receive the primary synchronization signal, the one or more processors are individually or collectively further operable to execute the code to cause the UE to:
detect an energy pattern corresponding to the primary synchronization signal, wherein the energy pattern indicates that at least one resource block of the first plurality of resource blocks is empty.

9. The UE of claim 1, wherein the numerical quantity of the first plurality of resource blocks comprises twenty resource blocks.

10. A user equipment (UE), comprising:
one or more memories storing processor-executable code; and
one or more processors coupled with the one or more memories and individually or collectively operable to execute the code to cause the UE to:
receive a power boost symbol prior to receiving a primary synchronization signal, the power boost symbol spanning a physical resource block in a synchronization signal block bandwidth;
receive the primary synchronization signal and a secondary synchronization signal based at least in part on the power boost symbol; and
communicate with a network entity in accordance with receiving the primary synchronization signal and the secondary synchronization signal.

11. The UE of claim 10, wherein, to receive the power boost symbol, the one or more processors are individually or collectively operable to execute the code to cause the UE to:
receive a set of tones associated with the power boost symbol in accordance with a sequence.

12. The UE of claim 11, wherein the sequence comprises a low peak to average power ratio computer generated sequence.

13. The UE of claim 10, wherein the one or more processors are individually or collectively further operable to execute the code to cause the UE to:
detect a correlation between a received energy of one or more tones associated with the power boost symbol and an expected energy associated with the power boost symbol, wherein receiving the power boost symbol is based at least in part on detecting the correlation.

14. The UE of claim 10, wherein at least one tone associated with the power boost symbol is boosted by a factor relative to at least one tone associated with the secondary synchronization signal.

15. The UE of claim 10, wherein a set of remaining physical resource blocks in the synchronization signal block bandwidth is empty.

16. A network entity, comprising:
one or more memories storing processor-executable code; and
one or more processors coupled with the one or more memories and individually or collectively operable to execute the code to cause the network entity to:
output a primary synchronization signal spanning a first plurality of resource blocks;
output a physical broadcast channel transmission associated with the primary synchronization signal, the physical broadcast channel transmission spanning a second plurality of resource blocks, wherein a numerical quantity of the first plurality of resource blocks is same as a numerical quantity of the second plurality of resource blocks; and
communicate with a user equipment (UE) in accordance with outputting the primary synchronization signal and the physical broadcast channel transmission associated with the primary synchronization signal.

17. The network entity of claim 16, wherein at least one resource block of the first plurality of resource blocks is empty.

18. The network entity of claim 16, wherein, to output the primary synchronization signal, the one or more processors are individually or collectively further operable to execute the code to cause the network entity to:
output the primary synchronization signal mapped to a first subset of the first plurality of resource blocks; and
output a synchronization signal block presence indicator mapped to a second subset of the first plurality of resource blocks.

19. The network entity of claim 18, wherein one or more tones located between the first subset of the first plurality of resource blocks and the second subset of the first plurality of resource blocks are empty.

20. The network entity of claim 16, wherein, to output the primary synchronization signal, the one or more processors are individually or collectively further operable to execute the code to cause the network entity to:
output the primary synchronization signal mapped to a first subset of the first plurality of resource blocks; and
output a secondary synchronization signal mapped to a second subset of the first plurality of resource blocks.

21. The network entity of claim 20, wherein one or more tones located between the first subset of the first plurality of resource blocks and the second subset of the first plurality of resource blocks are empty.

22. The network entity of claim 16, wherein, to output the primary synchronization signal, the one or more processors are individually or collectively further operable to execute the code to cause the network entity to:
output a primary synchronization signal burst comprising a first primary synchronization signal and a second primary synchronization signal, wherein each of the first primary synchronization signal and the second primary synchronization signal span the first plurality of resource blocks.

23. The network entity of claim 16, wherein, to output the primary synchronization signal, the one or more processors are individually or collectively further operable to execute the code to cause the network entity to:
output the primary synchronization signal in accordance with an energy pattern, wherein the energy pattern indicates that at least one resource block of the first plurality of resource blocks is empty.

24. The network entity of claim 16, wherein the numerical quantity of the first plurality of resource blocks comprises twenty resource blocks.

25. A network entity, comprising:
one or more memories storing processor-executable code; and
one or more processors coupled with the one or more memories and individually or collectively operable to execute the code to cause the network entity to:
output a power boost symbol prior to outputting a primary synchronization signal, the power boost symbol spanning a physical resource block in a synchronization signal block bandwidth;
output the primary synchronization signal and a secondary synchronization signal based at least in part on the power boost symbol; and
communicate with a user equipment (UE) in accordance with outputting the primary synchronization signal and the secondary synchronization signal.

26. The network entity of claim 25, wherein, to output the power boost symbol, the one or more processors are individually or collectively operable to execute the code to cause the network entity to:
output a set of tones associated with the power boost symbol in accordance with a sequence.

27. The network entity of claim 26, wherein the sequence comprises a low peak to average power ratio computer generated sequence.

28. The network entity of claim 25, wherein an energy of one or more tones associated with the power boost symbol has a correlation with an expected energy associated with the power boost symbol, and wherein outputting the power boost symbol is based at least in part on the correlation.

29. The network entity of claim 25, wherein at least one tone associated with the power boost symbol is boosted by a factor relative to at least one tone associated with the secondary synchronization signal.

30. The network entity of claim 25, wherein a set of remaining physical resource blocks in the synchronization signal block bandwidth is empty.
